(19) United States
(12) Patent Application Publication
(10) Pub. No.: US 2004/0003353 A1
(43) Pub. Date: Jan. 1, 2004

(54) Workflow integration system for automatic real time data management

(76) Inventors: Joey Rivera, New Albany, IN (US); Kathy Mathews, Louisville, KY (US); Frank A. Csapo, Louisville, KY (US)

Correspondence Address: PATTON BOGGS, PO BOX 270930, LOUISVILLE, CO, 80027, US

(21) Appl. No.: 10/436,718

(22) Filed: May 12, 2003

Related U.S. Application Data
(60) Provisional application No. 60/380,414, filed on May 14, 2002.

(51) Int. Cl. G06F 17/30

(52) U.S. Cl. 715/530; 715/507

(57) ABSTRACT

The Workflow Integration System uses pre-mapped electronic documents, termed Digital Forms, that are automatically routed within the organization's workflow environment (the “Organizational Domain”) along a defined Domain Path. A Digital Form is originated by a user pursuant to the implementation of a procedure within the organization. Once the Digital Form is retrieved by the user it is automatically populated with data stored within a database. After completing the user supplied new information sections of the Digital Form, the user submits the Digital Form, with the data input by the user along with all associated tracking and authentication information being extracted from the fields in the Digital Form and used to populate a record or data tables in a relational database. A Digital Form can be processed simultaneously by multiple users to thereby speed the execution of a task and associated documents can bind to the Digital Form to enable the compilation in real time of a complete transaction record that is routed electronically through the workflow process. The architecture for the Workflow Integration System thereby processes information in real-time and makes all processed information available to dissimilar data processors.

### CROSS-REFERENCE TO RELATED APPLICATIONS

This application is a U.S. Utility Patent Application based on and claiming priority to a U.S. Provisional Patent Application Serial No. 60/380,414 filed on May 14, 2002.

### FIELD OF THE INVENTION

The present invention relates to data management systems and, in particular, to a system that manages workflow, tracks the present location and status of both materials and personnel associated with an organization and captures data and information contained within organizational workflow, providing real time access to data relating to the present location and status of both materials and personnel and all information contained with an organizations workflow.

### PROBLEM

It is a problem in large organizations to track the present location and status of both materials and personnel, collectively termed “organizational assets” herein and to also capture and utilize information and data contained within the day-to-day organizational workflow, and maintain accurate, up-to-date access to all of the information contained within the organizational workflow. It is a further problem to maintain consistency of the data that characterizes the organizational assets and customers among many computer systems that are operational in an organization. These problems are especially acute in organizations that have a geographically dispersed set of organizational assets and customers as well as many computer systems, particularly in the case where some of these computer systems are legacy computer systems.

Information is the vital component that is processed by a data management system. The availability and accuracy of information contained within any data management system defines the usefulness of that data management system, irrespective of whether the data management system is paper-based, electronic, or a combination of the two. When critical information is trapped in files and folders, lying dormant in a fax machine or a mailbox, or sifting unused in a stack of paper documents, it delays the operations of the organization, lengthens an organization's response time and ultimately jeopardizes the efficient and accurate operation of the organization.

For a data management system to maintain its usefulness, it must provide real-time access to accurate information. Any data management system that is deployed to achieve this goal of real time data access must be unimpeded by the delays and high costs associated with the perpetual “paper chase”. The data management process that is operational in an organization must provide a seamless method of converting paper documents into an electronic format for storage on an electronic data management system. The electronic data management system must then be able to extract reliable information from the stored data, which information can be utilized by all authorized personnel.

Present data management systems fail to achieve this goal for any of a number of reasons. The inability to transition paper-based workflow to electronic format wherein data is extracted and utilized in real-time and the associated problem of the inability to integrate numerous records that relate to the same organizational asset, information or customer to provide a coherent and complete set of relevant information are primary failures of existing data management systems. A component of this difficulty is the extraction of the workflow of data among the various data processing and data storage modules that constitute a typical data management system and the maintenance of a consistent version of the data among these modules. Thus, there is presently no system that is able to achieve the above-stated goals.

### SOLUTION

The above-described problems are solved and a technical advance achieved by the present Workflow Integration System which uses pre-mapped electronic documents, termed Digital Forms, that are automatically routed within the organization's workflow environment (the “Organizational Domain”) along a defined Domain Path. A Digital Form is originated by a user pursuant to the implementation of a procedure within the organization. Once the Digital Form is retrieved by the user, it is automatically populated with data stored within a database. After completing the user supplied new information sections of the Digital Form, the user transmits the Digital Form, and the data input by the user, along with all associated tracking and authentication information, are extracted from the fields in the Digital Form and used to populate a record or data tables in a relational database. The Digital Forms can be self-populating in whole or part, in that the relational database extracts the relevant data from its records and/or tables and automatically populates the associated fields within the Digital Form to simplify the task for the user. A Digital Form can be processed simultaneously by multiple users to thereby speed the execution of a task and associated documents can bind to the Digital Form to enable the compilation in real time of a complete transaction record that is routed electronically through the workflow process. The architecture for the Workflow Integration System thereby processes information in real-time and makes all processed information available to dissimilar data processors.

The Workflow Integration System eases the information exchange among computer systems by tagging data, using Extensible Markup Language (XML), to allow disparate applications and systems to easily recognize the data. Data tags are templates defined in XML that serve as an interface for integrating the Workflow Integration System with third party systems/applications. Data exchange between systems takes place via data tags (XML). These data tags incorporate a predefined structure tied to an XML schema so that interacting systems understand the data transaction flowing between them. The universality of the data tagging design provides the Workflow Integration System the ability to perform a single source update on the data that characterizes the organizational assets, which in turn provides a global format for updating all other computer systems that are served by the Workflow Integration System to maintain a consistent version of the data among these systems. In addition to a single source update, each customer's and organizational asset's data record contains the present and historical information relating to the customer/organizational asset, the source of the stored information, and a notation of each authentication completed.

The Workflow Integration System is typically implemented as part of an integrated data management process to thereby provide a scalable solution to an organization's data management needs. Through the combined implementation of an effective method of coordinating, processing, validating, assimilating and disseminating information, the Workflow Integration System implements a complete solution for any organization tasked with the responsibility of processing large volumes of information. The use of this multifaceted deployment of crosslinked methods and systems typically includes by way of example: manual processing of paper documents; the conversion of existing paper documents into electronic form; the extraction of data obtained from the converted electronic documents; a WEB-based system that can transmit and receive electronic information among various customers and/or personnel; tracking of Digital Forms and the processing of the Digital Forms; and the ability to provide timely and cost-efficient distribution of all collected information to many different data processing systems.

Thus, the present Workflow Integration System allows disparate applications and data processing systems to easily recognize the data and manage this data in the appropriate manner to thereby integrate numerous records that relate to the same organizational asset or customer to provide a coherent and complete set of relevant information.

### BRIEF DESCRIPTION OF THE DRAWINGS

FIG. 1 illustrates in block diagram form the overall structure of the present Workflow Integration System;

FIG. 2 illustrates a typical data management system environment in which the present Workflow Integration System is operational;

FIG. 3 illustrates in flow diagram form, the process executed in the present Workflow Integration System to provide a customer or personnel with login access;

FIG. 4 illustrates in flow diagram form the process executed in the present Workflow Integration System to provide a worksheet form and the associated approval of the data entries contained therein;

FIG. 5 illustrates in block diagram form an example of a process that includes both sequential and parallel processing of a form.

### DETAILED DESCRIPTION OF THE DRAWINGS

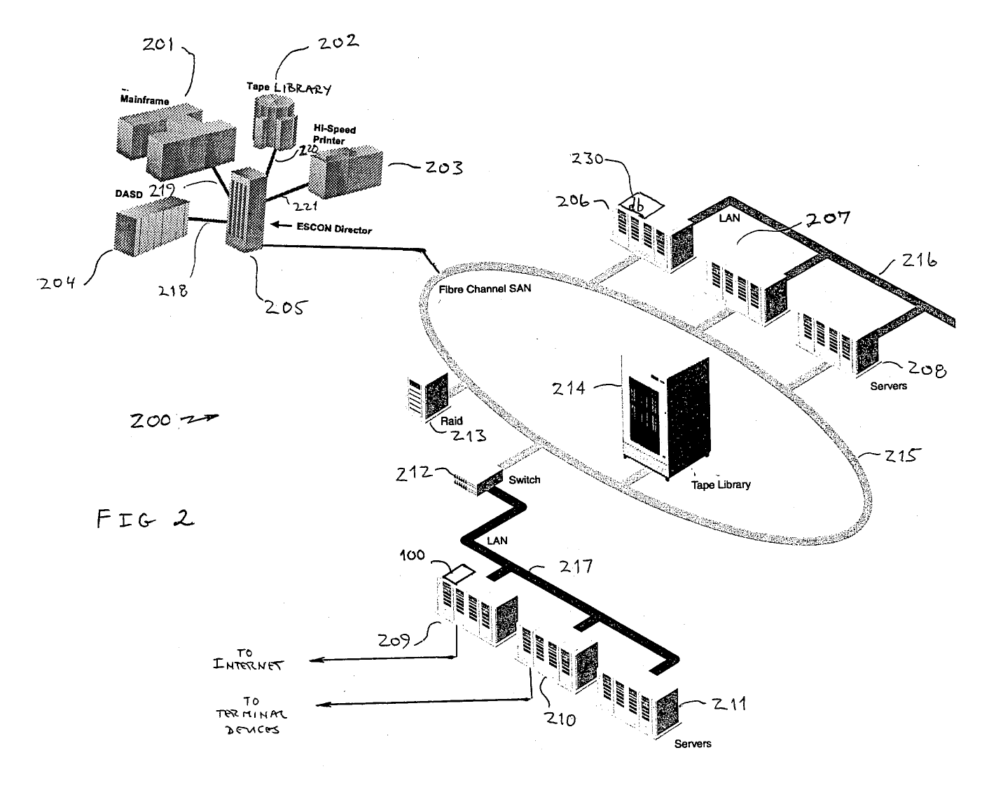

FIG. 2 illustrates a typical data management system environment in which the present Workflow Integration System is operational. This data management system architecture is simply illustrative of a typical configuration of computer processing resources and is intended to illustrate the issues that are encountered in the proper processing, storage and maintenance of information in a large organization. This description is not intended to limit the applicability of the present Workflow Integration System to other data management system environments and is solely intended to provide a framework for the accompanying description of the present Workflow Integration System.

Organizations have experienced a rapid growth in the volume of data that is required for their operation and an associated increase in the time required to capture, store, process and retrieve this data in a data management system 200. Increasing the speed of operation of the data management system 200 is critical to cost efficient operation, as is the need to increase the efficiency at which data is exchanged among the data processors 201, 206-211 and data storage modules 202, 204, 213, 214 in the data management system 200. As shown in FIG. 2, a typical data management system installation can include a mix of the following elements: one or more mainframe data processors 201, 206-211, one or more automated tape cartridge library systems 202, 214, one or more DASD systems 204, one or more high speed printers 203, one or more RAID data storage 213 systems. For example, some of these disparate modules 201-204 can be connected via channels 218-221 in a point-to-point manner to a director 205 which serves to interconnect these modules 201-204 as needed to distribute the data that is managed by the data management system 200. Alternate interconnection configurations are possible and many data management systems use the Fibre Channel-based Storage Area Network (SAN) 215 and/or a Local Area Network (LAN) 216, 217 to interconnect multiple data processors 206-211 with I/O devices 213, 214 and/or other processor configurations. As shown in FIG. 2, a plurality of data processors 209-211 are interconnected via Local Area Network 217 with each other and a server 212 which serves as an interface to Fibre Channel-based Storage Area Network (SAN) 215. A Fibre Channel is a set of standards that define a multi-layered architecture that transfers data on a physical medium among interconnected data processing and I/O devices. One or more of the data processors 209 can serve as a router to interconnect data management system 200 to an external IP network, such as the Internet, to provide remote access to customers and personnel. One or more of the data processors 210 can serve data terminals that are located within the physical premises of the organization and data links (not shown) can interconnect remotely located data processors (not shown) with the elements shown in FIG. 2.

This description illustrates the complexity and extent of data management systems in a large organization and provides examples of different interconnection architectures. Within this environment, it is a problem for the data management system 200 to manage data that enables the personnel in the organization to track the present location and status of both materials and personnel, collectively termed “organizational assets”, and to extract the organizational knowledge contained within the workflow, and maintain accurate records relating to the customers who are served by the organization. It is a further problem to maintain consistency of the data that characterizes the organizational assets and customers among the many data processors 201, 206-211 and data storage modules 202, 204, 213, 214 that are operational in an organization. These problems are especially acute in organizations that have a geographically dispersed set of organizational assets and customers as well as many computer systems, particularly in the case where some of these data processors are legacy data processors.

### Workflow Integration System Architecture

The Workflow Integration System 100 captures data and information contained within organizational workflow into a relational database that provides real-time access to data previously only available through conventional methods such as opening a filing cabinet and looking through a file. By extracting all information from each Digital Form as it is processed, the Workflow Integration System 100 not only provides real-time access, but also provides real-time data updating. Thus, the organizations informational knowledge base is literally updated as workflow is processed.

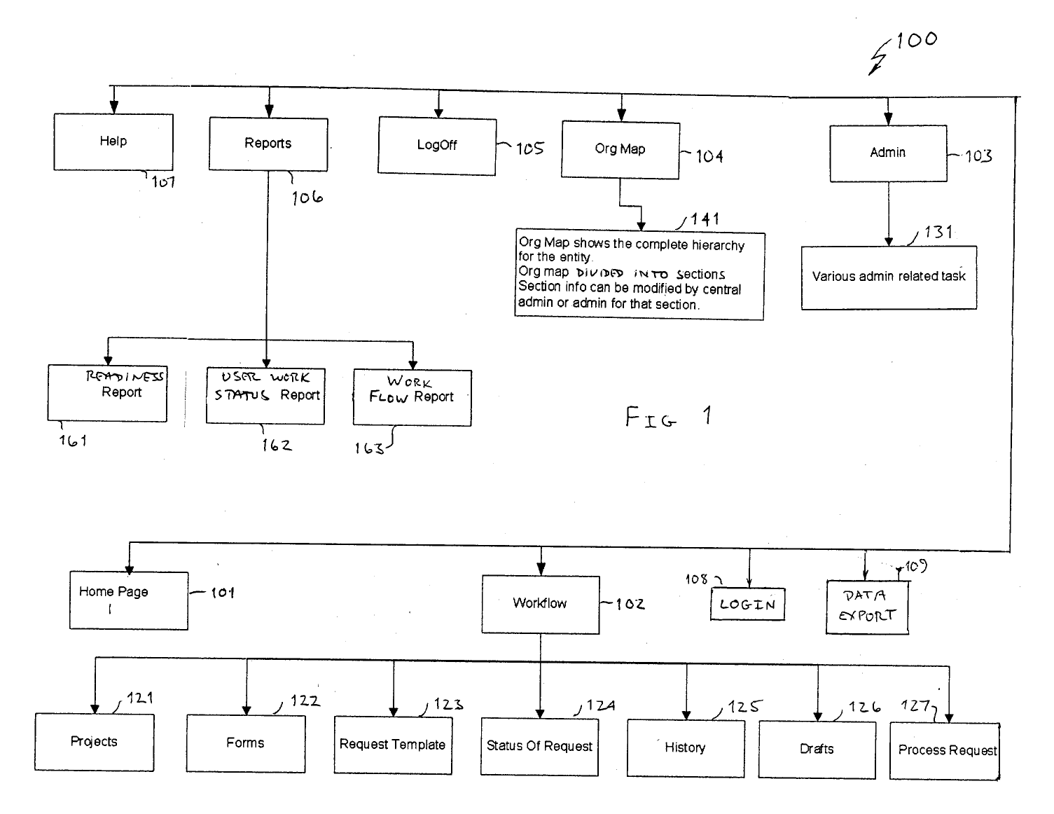

The Workflow Integration System 100, illustrated in block diagram form in FIG. 1, executes on one or more of the data processors 201, 206-211 to manage the coordination, processing, validation, assimilation and dissemination of information that is managed by the data management system 200. In this environment, users, who may be customers or personnel of the organization, access the Workflow Integration System 100 to retrieve information stored in the data management system 200, or input new information to the data management system 200, or update information that is resident in the data management system 200. For simplicity of description, the following examples use the case of personnel of the organization, but a similar paradigm applies to customers. In order to avoid confusion, the individuals who access the Workflow Integration System 100 are collectively termed “users” herein.

As shown in FIG. 1, there are numerous functional components that constitute the Workflow Integration System 100, and some of these are not described in detail herein since they are not essential to an understanding of the invention. For example, the help function 107 and the logoff function 105 constitute routine operations. Similarly, the administration function 103 enables authorized administrative personnel to access the task processes 131 to administer the operation of the Workflow Integration System 100. The Home Page function 101 represents the WEB portal that enables users to access the Workflow Integration System 100 from remote locations via the Internet or other IP-based network. The reports function 106 provides management access to numerous report functions that are executed by the Workflow Integration System 100 to enable the administrators or users to retrieve information regarding the operation and performance of the Workflow Integration System 100 or specific records maintained in the database system 230. A number of report categories are listed for illustrative purposes: Real-time readiness status of troops within any given unit in a branch of the military 161; all requests processed by a given user 162; the current status and position of any workflow currently routing within the system 163. There can be various other functions and subsets of functions that would be implemented in a typical Workflow Integration System 100 and these illustrate the genre of functions typically implemented.

### Digital Forms and Domain Paths

In order to more fully appreciate the operation of the Workflow Integration System 100, it is necessary to understand several underlying concepts that apply to the processing of information by the Workflow Integration System 100. These include Digital Forms, Domain Paths and the Organizational Domain.

The Digital Forms constitute the base documents, forms and/or paperwork that are utilized for day-to-day work within any organization. The format used for a Digital Form is a function of the organization and the data entry needs for the particular task at hand. The Digital Forms are pre-mapped electronic documents that are automatically routed within the organization's workflow environment and enable the users to populate the Digital Form with data, review the data, approve the data and route the data to the appropriate destination(s). The result of such data entry and management is the creation of the information that is needed by the organization for its operations. As described in more detail below, a Digital Form is originated by a user pursuant to the implementation of a procedure within the organization. The user requests access to a Digital Form via a user interface and the Digital Form is then displayed on the user's data terminal device. Once the Digital Form retrieved by the user is populated with data and submitted to the Workflow Integration System 100, the data input by the user as well as all associated tracking and authentication information is extracted from the fields in the Digital Form and used to populate a record in a relational database 230 which executes on one 206 of the data processors 201, 206-211. Some of the Digital Forms can be self-populating in whole or part, in that the relational database 230 extracts the relevant data from its records and automatically populates the associated fields within the Digital Form to simplify the task for the user. The architecture for the Workflow Integration System 100 thereby processes information in real-time and makes all processed information available to dissimilar data processors.

The internal structure of the organization is mapped into a global schematic that defines the digital work flow processing, which global map is termed the Organizational Domain. The routing of a Digital Form comprises the workflow path required for any particular work item to be properly processed by the personnel of the organization, the Domain Path. The Domain Path is defined by one or more of the following routing attributes: user, business rules, security clearance, and multi-layer combinations of these factors. The Workflow Integration System 100 combines a powerful relational database 230 with organizational mapping that empowers self-populating Digital Forms with the ability to route along pre-defined Domain Paths within an organization defined Organizational Domain.

The path that a particular work item takes through the organization in the processing of a work item is termed Domain Path herein. The Domain Path typically comprises a hierarchical structure that functions to route the Digital Form(s) through a selected layer of the organization for data entry, and thence to successively higher layers in the organizational hierarchy for approvals and/or further data entry. As digital workflow is routed along Domain Paths, personnel who receive the Digital Form for processing are provided with the ability to process this workflow through secure digital signature technology. Each submitted Digital Form is automatically assigned a tracking number and instantly routed along the organization's pre-defined Domain Path for this Digital Form for processing or, in the event the Digital Form is not pre-programmed with a Domain Path, routed to the office or person identified by the processing agent. The tracking number assigned to a particular Digital Form is a unique identifier which is used throughout the Workflow Integration System 100 to provide instant status information of workflow process and a complete audit trail of any document(s).

A collection of Digital Forms that relate to a common transaction can be termed a Project. The use of a Project delimiter on the Digital Forms enables a user to assemble a collection of related Digital Forms and/or other documents into a common related file, with subsets of the aggregated Digital Forms and documents being capable of traversing different parallel Domain Paths.

### Overall Application of the Workflow Integration System

The Workflow Integration System's modular architecture is designed for both flexibility and scalability. This translates into a system that has the capability to process and disseminate real-time information resulting in:

1. One source of object information containing information source and history data, thereby requiring only one change notification from a user to update object information organization-wide; or

2. Global deployment of a workflow integration system where Digital Forms that contain a pre-programmed Domain Path data are routed and processed in an Organizational Domain to provide real-time data up-dates and the ability to track and know where all information is at all times.

A typical organizational solution to the data management problem faced by an organization is the deployment of a “complete solution” with the following elements:

1. Manual Processing Center—Service center for processing and conversion of new and pre-existing forms into digital records.

2. Electronic Document Capture System—Process that converts paper information into electronic records.

3. Workflow Integration System that combines a powerful database with organizational mapping of the organization thereby enabling self-populating Digital Forms to route along pre-defined Domain Paths within a user defined Organizational Domain.

4. Centralized process of collecting, updating, and maintaining information related to aliens and associated entities or persons.

5. Deployment of processed information to disparate computer systems.

The Workflow Integration System 100 provides one source of information that contains information source and history, thereby requiring only one change notification from a user to update information on an organization-wide basis.

### User Login Process

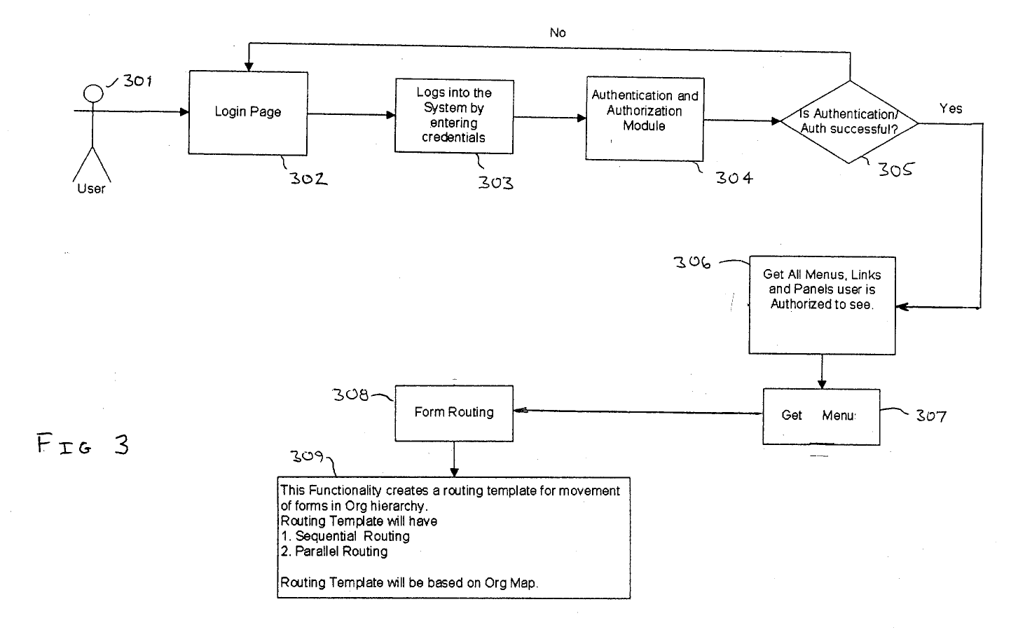

FIG. 3 illustrates in flow diagram form, the process executed in the present Workflow Integration System 100 to provide a user with login access. The Workflow Integration System 100 enforces tight operating system security by using robust passwords and maintaining only a minimal number of access points to all servers. For additional security, all operating systems can include technology such as smart card software, which provides digital signing, user authentication and certificate-based log-on to networks and computer systems. Smart card software is designed to enable the use of encoded cards to fully secure user workstations, helping to protect systems against unauthorized access to mission-critical information and applications. The card contains a user's private keys to be used for secure authentication to computer systems within a public key infrastructure (PKI). Smart card software combines the security of smart cards with the strength of digital certificates used for accessing networks, applications and data. Smart card software is a flexible platform designed to enable the organization to easily migrate from passwords to digital certificates to comprehensive PKI and single sign-on implementations.

In addition, the server infrastructure is used in conjunction with load-balancing functionality to prevent access problems and maximize uptime. All database-server requests are dynamically load-balanced with encrypted memory-only Cookies, allowing the Workflow Integration System 100 to maximize the efficiency of its Web-based servers. This approach allows individual Web servers to be switched out for planned maintenance or unanticipated repair without any interruption in service.

The login process 108, executing as shown in FIG. 3, illustrates an Internet access of the Workflow Integration System 100. For example, a user 301 at a data terminal, such as a personal computer (not shown) initiates a session with the WEB portal server 209 of the Workflow Integration System 100. The WEB portal server 209 transmits the login page at step 302 to the user 301 thereby enabling the user 301 to enter data into the required login fields of the login page or by use of a Smart Card or other authentication instrumentality at step 303. At step 304, the authentication and authorization module compares the data input by the user at step 303 with the expected user login data as stored in the user's login profile. If there is a failure to match the user provided data with that stored in the user's login profile as determined at step 305, then a message is returned to the user 301 on the login screen, indicating a failure of the login process. If the user 301 successfully traverses the login process, at step 306, the Workflow Integration System 100 executing on the WEB portal server 209, retrieves a list of the permissions assigned to this user 301 from the user's profile. At step 307, the Workflow Integration System 100 activates the WEB portal server 209 to transmit the appropriate menu screen to the user 301 to thereby enable the user 301 to initiate the data input/update process.

A typical transaction, described below, enables the user 301 at step 308 to select the Domain Path (routing of the Digital Form) that has been retrieved from the Workflow Integration System 100. If the Domain Path is immutable, then the particular Digital Form is populated with this predefined Domain Path. The population and/or editing of the Domain Path takes place at step 309 and the Digital Form is then staged to be automatically distributed to the destinations identified by the Domain Path.

### Transaction

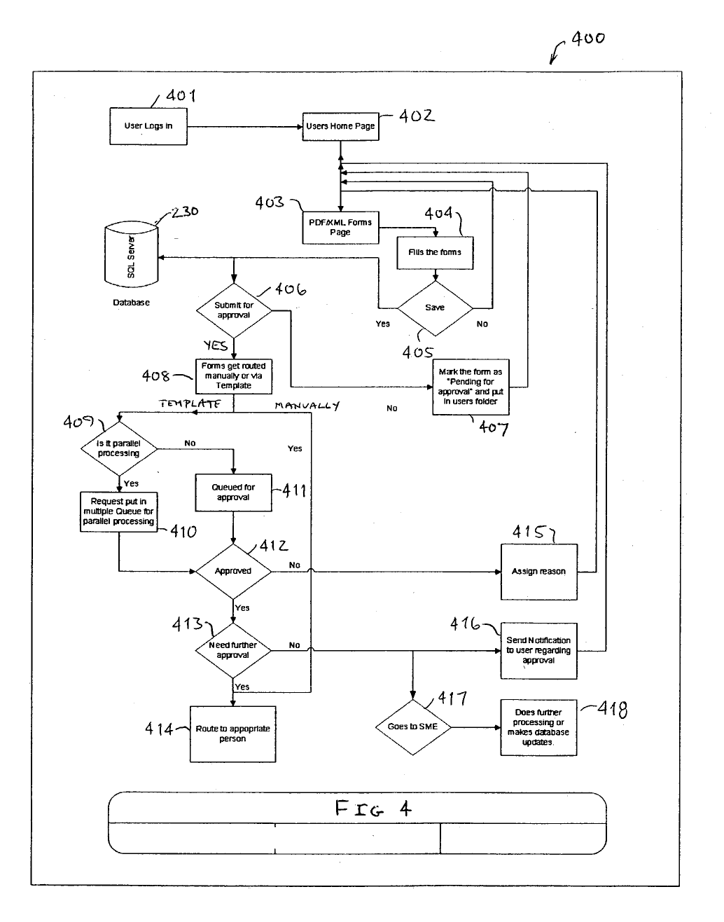

FIG. 4 illustrates in flow diagram form the process executed in the present Workflow Integration System to provide a worksheet form and the associated approval of the data entries contained therein. At step 401, the user logs in as described above with respect to FIG. 3 via the user's home page as shown at step 402 and is authenticated by the Workflow Integration System 100. The user is authorized to access certain forms maintained by the Workflow Integration System 100 and a forms page, selected by the user, is retrieved from the forms database 122 and displayed to the user at step 403 and the user can fill out the form at step 404. The user can determine at step 405 whether to save the completed form. If not, the process cycles back to step 403 where the user can select another form to access or exit the process. If the user elects to save the form at step 405, the form and its contents (the data input by the user) is saved in a draft form segment of database 230 and, at step 406, provides the user with the ability to submit the form for approval at a later date. If the user determines that it is not time to submit the form for approval, the process returns to step 403 and the form is stored in memory and marked as “pending for approval. If at step 406 the user elects to submit the form for approval, the forms approval process 128 advances to step 408 where the form is routed pursuant to the Domain Path.

The form can be routed either manually or automatically based on the Domain Path. The user can, if authorized, define the Domain Path for the approval path process for a form. Typically, in the instance of a manually routed form, a selected individual is identified by the user and the process advances to step 414 where the completed form is automatically routed by the Workflow Integration System 100 to the user identified individual. If the organizational user has elected to have the completed form routed via an automated process using a pre-defined Domain Path 123, then processing advances to step 409 where the Workflow Integration System 100 determines whether the processing of the form is parallel or sequential. This process is described in further detail below. If there is a sequential processing of the form, the process executes as described in FIG. 4 and then cycles to each successive user (initiates at step 403 for example). If there is parallel processing, then the process advances to step 410 where the completed form is placed in multiple queues, one for each of the individuals who must further complete the form or approve the form. At step 412, the Workflow Integration System 100 monitors the approval process that takes place at the next successive layer of the approval process as defined in the Domain Path. If approval is not obtained, the Workflow Integration System 100 at step 415 associates a reason for the denial of approval and routes the annotated form to the user and the process returns to step 403. If the form is approved, the Workflow Integration System 100 notifies the original submitter of the approval and advances to step 413 where the Workflow Integration System 100 determines whether further approval is required. If further approval is required, the process advances by the form being transmitted to the next identified individual in the approval process defined in the Domain Path at step 414. If no further processing is required, then the Workflow Integration System 100 at step 416 sends a notification to the user, indicating that the form has been approved. The Workflow Integration System 100 at step 417 enters the data export process 109 and transmits the completed and approved form to the designated destination that is the recipient of the completed form (which can be another process, such as a mail server) and/or updates the database with the newly approved data. At step 418, the Workflow Integration System 100 updates the database 430 to store the form in memory and associate the approvals with the form.

Extensible Markup Language (XML) is a typical paradigm used for coding the form, since XML is universal and has the ability to make information understandable to dissimilar computer systems. XML eases the information exchange by tagging data so disparate applications and systems can easily recognize it. The Workflow Integration System 100 therefore combines a powerful database with organizational mapping that enables self-populating Digital Forms the ability to route along pre-defined Domain Paths within an organization defined Organizational Domain.

### Domain Paths

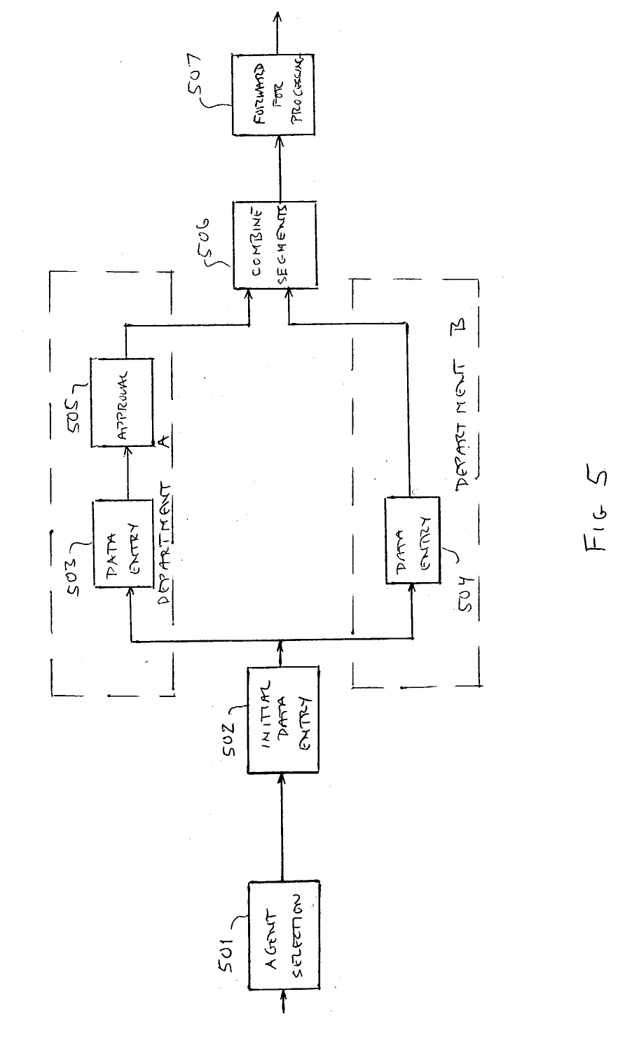

The Domain Paths can be sequential and/or parallel. In this regard, the Workflow Integration System 100 maintains an Organizational Database 141 which schematically defines the various departments of the organization and their interrelationships. For example, FIG. 5 illustrates in block diagram form an example of a process that includes both sequential and parallel processing of a Digital Form.

A Digital Form is typically comprised of a series of data fields that are pre-populated by the system and others that must be completed by the users to provide the data necessary to complete a data collection and approval activity that is associated with the processing of a request or in the execution of a process that is implemented by the organization. In a traditional process, the processing of a request is done sequentially, with data entry being affected by a user and the completed form then being delivered to a supervisor or another employee for approval or further processing. The processing is exclusively sequential and the form in a paper-based environment is thereby handled many times and physically delivered to many locations in the organization before being finalized and stored in a document storage location. The tracking of the present status of the form and its present location is difficult at best. This traditional mode of operation is time consuming, expensive and prone to errors and delays.

The present Workflow Integration System 100 overcomes the problems associated with the traditional forms processing paradigm by the use of Digital Forms and Domain Paths, with an associated Digital Form tracking process. In particular, the use of a Digital Form eliminates the need for the handling of a paper document and the routing of the Digital Form is rapid, since it is done electronically. In addition, the routing of the Digital Form is tracked by the use of tracking and history data that is associated with each Digital Form. As noted above, each instance of a Digital Form is assigned a unique tracking number so that the Workflow Integration System 100 can retrieve the form from the database and retrieve not only the form, but also its present contents. The use of a user authentication process, described above, also ensures that the users who process the Digital Form are authorized to do so, and the identity of the user who provides data entry or approval of each data field in the Digital Form is tracked in the database. Thus, if a user initiates an inquiry regarding the present location and status of a particular Digital Form, the Workflow Integration System 100 can enter the form history process 126 and query the database to determine this information. The form history process 126 maintains data in the database record associated with each Digital Form that reflects the identity of each user who inputs data into the Digital Form, the authentication process executed to authenticate the data entries, as well as the present status and location of the Digital Form in the entire processing cycle.

In order to expedite the processing of a Digital Form, the Domain Map can be divided into sequential and parallel processing segments, with some Domain Mps being nested within a global Domain Map. In particular, for example a particular Digital Form can have a data entry segment 502 that is assigned to a certain category of the personnel of the organization. The user assigned to perform this task can be selected via an automated “agent selection” process 501 as is well known in the industry, to initiate the processing of the Digital Form. Once this first step is completed, the Digital Form may be routed in parallel to two separate paths for processing, with the separate paths being defined by the Domain Map associated with the Digital Form, or being defined in part by a Domain Map that is in effect for a particular segment of the Digital Form, and defined by the organization that executes the processing of the segment of the Digital Form. For example, further data entry may be required from two separate but cooperative departments in the organization. In this case, the Digital Form is electronically parsed by the Workflow Integration System 100, with a portion of the Digital Form being editable only by the members of a first department 503 and another portion of the Digital Form being editable only by the members of a second department 504. All users may be able to view the entirety of the Digital Form or, in the alternative, the organization can restrict users from viewing those portions of the Digital Form which they do not have approval authority, but in either event the separate respective users can only edit their portion of the Digital Form. Alternatively, some portions of the Digital Form may be blocked from view.

In addition, the editing of the Digital Form by the members of the first department at step 503 may require supervisory approval at step 505, while the editing of the Digital Form by the members of the second department at step 504 may not require supervisory approval. The Workflow Integration System 100 monitors the status of the Digital Form and at step 506 combines the outputs received from the parallel processing and routes the results at step 507 to the next step in the forms processing process. Additional processing may take place in series or parallel or various combinations thereof until the operation is completed and the Digital Form is exported by the data export process 108 to the designated destination.

### Project

The above description of the Digital Form is not limited to the processing of a single electronic document. As the Digital Form traverses the Domain Path, additional Digital Forms and/or supporting documents can be included in the process. For example, in the processing of a loan application, supporting financial documentation is required to support a loan application. In the Workflow Integration System 100, the supporting documentation can be scanned into electronic form and appended to the Digital Form as the Digital Form proceeds through the approval process. In the instance where multiple Digital Forms are bound together and/or supporting documents appended, the resultant collection of information is termed a “Project.” The Project documentation, in the above noted parallel processing operation can be subdivided as the Digital Form traverses the process. Thus, at step 503, the Digital Form with supporting document A can be delivered to the first department while the Digital Form and supporting document B can be delivered at step 504 to the second department. The user in the first department may initiate a second Digital Form, which becomes part of the Project, while the user in the second department may initiate a third Digital Form and adds supporting document C to the Project. Thus, when the documents are assembled by the Workflow Integration System 100 at step 506, the Project now includes the initial Digital Form and its supporting documents A and B along with the second and third Digital Forms and supporting document C.

### Application Example for the Workflow Integration System

The following example will help illustrate one possible implementation of the Workflow Integration System:

A foreign citizen enters an embassy in Cairo to apply for a nonimmigrant visa to the United States. The consular officer logs onto their secure account within the WEB-based Workflow Integration System 100 and accesses the Digital Forms section. The Digital Forms section provides the consular officer with access to all INS forms for which they have security clearance. The consular officer then selects the appropriate Digital Forms to begin processing the alien's request for a visit. As the applicable Digital Form(s) are opened, each form automatically populates with the consular officer's standard information. Furthermore, if the applicant has previously applied for a visa to the United States or been entered into the Workflow Integration System 100 for any other reason the consular officer can access the applicant's prior information, review the historical files and then allow the Digital Forms to be self-populated with the applicant's last known information. In addition, the Workflow Integration System 100 can be enhanced to include additional data inputs such as digital photographs and digital fingerprint scans, if requested by INS. Following the completion of the Digital Forms, the consular officer authenticates the form with their secure digital signature. The submitted Digital Forms are then automatically assigned a tracking number and instantly routed along the organization's pre-defined Domain Path for processing or, in the event the Digital Forms are not pre-programmed with a Domain Path, routed to the office or person identified by the consular officer. The tracking number is a unique identifier which is used throughout the Workflow Integration System 100 to provide instant status information of the workflow process and a complete audit trail of the document.

While the Digital Forms are in the workflow process along a given Domain Path, the Workflow Integration System 100 provides the capability for any authorized personnel to instantly ascertain workflow information such as:

The number of approvals required in order for the request to be fully processed;

The exact location of the workflow with the ability to identify the person(s), department or office(s) that is presently processing the request;

A graphical representation of the Domain Path that is required for the approval of the request;

A graphical representation of the current location of the Digital Forms on the Domain Path; and

A graphical representation of the current status of the review process.

In the event an alien is identified for Special Registration requirements in the United States, upon arrival to the United States the INS immigration inspectors would have real-time access to all sections (for which security access has been granted) of the alien's file including fingerprints and facial-recognition. Thereafter, the Workflow Integration System 100 could automatically generate reports identifying Special Registration non-immigrants who have remained in the country for more than thirty (30) days without having checked in at the nearest INS office or sub-office.

### Data Access Security

Access to sensitive information must be protected based upon user access roles and depending on status. The Workflow Integration System 100 has the capability of protecting information based upon organization defined access roles and the status of information within the system. The Workflow Integration System 100 controls, through use of specific security features, access to information that only properly authorized individuals, or processes operating on their behalf, has access to read, write, create, or delete information. The Workflow Integration System 100 implements a set of organization defined rules that are used by the Workflow Integration System 100 to determine whether a given subject can be permitted access to a specific record. The Workflow Integration System 100 enforces an organization defined security policy that can effectively implement access rules for handling sensitive data (e.g., classified). In addition, discretionary security controls can be implemented to ensure that only selected users or groups of users may obtain access to specific data (e.g., based on a “need-to-know”). In order to control access to information stored in a computer (according to the rules of the mandatory security policy) it must be possible to mark every object with a label that reliably identifies the object's sensitivity level (e.g., classification), and/or the modes of access accorded those subjects who may potentially access the object.

Each access to information can be mediated based on who is accessing the information and what classes of information they are authorized to deal with. This identification and authorization information is securely maintained by the computer system and will be associated with every active element that performs security-relevant actions within the Workflow Integration System 100. The Workflow Integration System 100 is able to record the occurrences of security-relevant events in an audit log. Audit data is protected from modification and unauthorized destruction to permit detection and after-the-fact investigations of security violations.

### Data Integrity

There must be data-integrity and quality-assurance safeguards to ensure that accurate and uniform data is maintained and to provide reverse look-up functionality. The Workflow Integration System incorporates a series of manual and electronic methods for maintaining data-integrity and quality-assurance. All information undergoes a series of screening, validation and authentication testing prior to populating a database. As an additional safeguard, the Workflow Integration System maintains transaction tracking information which includes the date, time, user ID, source, mail verification, double text entry, quality review and system reports. Each method reinforces data integrity and safeguards accurate, real-time information is maintained. Furthermore, the Workflow Integration System incorporates broad search and retrieval functions that provide: reverse look-up functionality; the capability to search on any data element or through all historical information; plus the capability to visually review all previously submitted forms and documentation that have been scanned into the Workflow Integration System.

The Workflow Integration System has complete tracking and audit trail capability that includes the following attributes regarding the physical entry of address information: date of receipt, date of entry into the system, date and type of authentication and verification, effective dates of information, source of information, individual who entered the information, and annotation of record. Furthermore, as the Workflow Integration System is utilized for work flow processing, each request, or job, is automatically assigned a unique tracking identifier which will provide a complete audit trail within the Workflow Integration System.

The Workflow Integration System has a method to annotate a level of trust for each address record depending on address source and reliability. The Workflow Integration System contains file annotation that allows a user to enter comments regarding the level of trust for each address record. The Workflow Integration System also tracks each verification and authentication process providing a quick reference for a user who is investigating any potential problem.

The Workflow Integration System has the ability to automatically generate a “level of trust” based on the quality and quantity of authentication performed on each record within the Workflow Integration System. The confidence level of any authentication is based on the perceived reliability of the information database against which the information is compared. Furthermore, as the frequency of data matches occur, so does the probability of the accuracy of the information. The result is the Workflow Integration System can perform authentication checks which tabulate the frequency of recurring matches together with the addition of a weighted confidence level based on the source of the information which is used to authenticate, thereby producing a “system-generated” level of trust for each record.

### Data Integrity Check Process

The users of the Workflow Integration System are able to mark an object data as invalid with a reason until information can be corrected or validated. The Workflow Integration System provides authorized users with the ability to flag an address as invalid and provide an annotation with a reason for the flag together with any instructions for further authentication or action required. In the event object data has been flagged, the Workflow Integration System can: i) automatically route the record to any specified organization personnel or department for further processing; ii) automatically route the record based on predefined business rules; and/or iii) provide the organization with real-time reports without any programming intervention.

User-generated reports include historical and statistical outputs in addition to ad-hoc reports that do not require programming intervention. The Workflow Integration System maintains all historical information in a database which provides broad based search and retrieval capabilities for real-time ad hoc, historical and statistical outputs. Compilation of these reports will not require programming intervention.

### Legacy Computer System Interoperability

The Workflow Integration System has the capability to send and receive object data information electronically to and from legacy systems as well as other designated organizations or government agencies within organization rules. The Workflow Integration System utilizes a universal XML format that can make information understandable to dissimilar computer systems. An application that receives an XML file “automatically” knows how the data is structured, making it easier to process the information and shuttle it between systems.

The solution is scalable to meet evolving needs and the Workflow Integration System has been designed to process information in real-time and make the information available to dissimilar computer systems. The system is WEB-based and combines a powerful database with organizational mapping that enables self-populating Digital Forms the ability to route along pre-defined Domain Paths within a user defined Organizational Domain. The system architecture provides broad, flexible and scalable capabilities allowing a user the freedom to utilize the system for a single, limited feature such as Change of Address updating or to provide organization wide electronic work flow integration.

### Electronic Conversion of Existing Documents

The Workflow Integration System integrates customizable document capture with technology to effectively capture information from existing technologies and yet remain flexible for future technological needs. The information capture process commences with the conversion or receipt of a document in electronic form. The process for hard copy documents begins in a manual processing center, where the documents are scanned into the Workflow Integration System.

The module server governs the document capture process and distribution of the technician workload and acts as a virtual manager that automatically routes data to the next available technician for processing. This automated load balancing system helps to ensure the highest level of productivity from all of the processing technicians. Furthermore, it identifies and eliminates bottlenecks by redistributing data thereby lowering processing costs due to the increased efficiencies. In addition, the module server provides the capture of complex and diverse data while maintaining the integrity of the data as it is routed through each process. For the transition of paper to electronic form, the Workflow Integration System uses a high-speed commercial scanner that has integrated leading edge scan technology. This technology captures both a full-color and a black-and-white image from a single scan. Having both a color image and a binary image helps in producing the greatest flexibility within the capture of data process.

Once documents have been imported or scanned, the Workflow Integration System implements a series of fully automated processes in which documents are: 1) cleaned up; 2) classified based upon business rules established by the organization; and 3) prepared for data extraction. Image cleanup may involve any one or more of the following processes: de-speckling, “noise” reduction, de-skewing, page orientation, and other image preprocessing functions. The classification process involves automatically identifying the type of document utilizing page and document identification. Following this process, the data extraction begins.

### Data Extraction and Authentication Process from Pre-Existing Paper Documents

The electronic conversion process outlined above, is then followed by a data verification and authentication process which: (i) drastically reduces the amount of technician time for processing; (ii) limits the opportunities for processing errors; and (iii) accelerates the transfer of real-time, accurate information into INS databases.

The authentication process includes, by way of example and not limitation, the following steps:

1. A predetermined form is scanned and coded into the Workflow Integration System.

2. Once scanned and processed, the document is then routed to a queue where the work load balancing system distributes scanned documents to the next available processing technician. The technician receives the pre-coded document in a split screen format. On the left of the screen is the scanned image of the original paper document and on the right is a data entry version of the form that has been pre-populated with information from the scanned document. The technician verifies and, if necessary, corrects the pre-populated information and then transmits the completed form. The technician is then prompted to re-enter all of the information using the scanned form that is still shown on the left side of the screen. In the event of any discrepancies between the first entry and the second entry, the technician will be prompted with a data entry screen with unmatched data highlighted. The technician will then make any final editing entries and submit the data for system authentication. This double entry system dramatically reduces data processing errors.

3. Any form which the technician is unable to process (i.e. illegible, missing information, etc.) is routed to a processing specialist for further review and action.

4. Processed forms are routed to an intermediary database for authentication. The authentication process:

Automatically generates a non-forwardable confirmation letter to the user notifying the user that the data change has been received and processed.

In the event the correspondence is returned indicating the alien does not live at that address, the system will immediately flag the alien's file. The information flagged as unverified is then available to personnel in the form of real-time reports generated without any programming intervention.

Cross authentication with existing databases.

Data scrub for such items as City and Zip Code matches.

Authentication against a national change of address system.

Authentication by any additional criteria established by the organization.

Upon successful completion of the authentication process, the data is available for all served computer systems.

### SUMMARY

The present Workflow Integration System uses pre-mapped Digital Forms, which are automatically routed within the organization's workflow environment along a defined Domain Path, to efficiently process information and maintain consistency and accuracy of the information.

What is claimed:

1. A workflow integration system for automatically routing pre-mapped electronic documents within an organization's workflow environment, comprising:
domain path means for defining a routing path for an electronic document through said organization;
digital form memory means for storing a plurality of pre-mapped electronic documents, each of which includes at least one data field for receipt of data provided by a user;
digital form processing means, responsive to a request input by a user, for retrieving one of said plurality of pre-mapped electronic documents from said digital form memory means for use by said user to submit data that is input into at least one of said data fields of said retrieved pre-mapped electronic document; and
database means for automatically storing said data input by said user.

2. The workflow integration system of claim 1 wherein said database means comprises:
data extraction means for extracting at least one of said data input by said user, tracking and authentication information from associated fields in said submitted pre-mapped electronic document; and
data storage means for populating a record in a relational database with said extracted at least one of data input by said user, tracking and authentication information.

3. The workflow integration system of claim 2 further comprising:
data retrieval means for enabling a user to access said record stored in said relational database to retrieve data therefrom.

4. The workflow integration system of claim 1 further comprising:
routing means, responsive to said user submitting said retrieved pre-mapped electronic document, for transmitting said submitted pre-mapped electronic document to a destination defined by said routing path for said submitted pre-mapped electronic document.

5. The workflow integration system of claim 1 further comprising:
digital form population means for automatically populating said retrieved pre-mapped electronic document with data stored within a database.

6. The workflow integration system of claim 5 further comprising:
relational database means for extracting data relevant to said retrieved pre-mapped electronic document from its records.

7. The workflow integration system of claim 1 further comprising:
parallel processing means for simultaneously processing said retrieved pre-mapped electronic document by multiple users.

8. The workflow integration system of claim 7 wherein said parallel processing means comprises:
means for parsing said retrieved pre-mapped electronic document into a plurality of sets of said data fields; and
means for enabling a selected subset of said multiple users to input data into only a one of said plurality of sets of data fields.

9. The workflow integration system of claim 8 wherein said parallel processing means further comprises:
tracking means for monitoring the completion status of each of said plurality of sets of data fields.

10. The workflow integration system of claim 1 further comprising:
data tagging means for enabling disparate applications and systems to recognize the data.

11. The workflow integration system of claim 10 wherein said data tagging means comprises:
a plurality of templates defined in XML that serve as an interface for integrating with third party systems and applications.

12. The workflow integration system of claim 10 wherein said data tagging means comprises:
predefined data structure means tied to an XML schema so that interacting systems understand the data transaction flowing between them.

13. The workflow integration system of claim 1 further comprising:
data update means for performing a single source update on the data that characterizes the organizational assets.

14. The workflow integration system of claim 1 further comprising:
tracking means for storing historical information relating to the submitted pre-mapped electronic document, the source of the submitted data, and a notation of each authentication process completed in the submission of said data.

15. The workflow integration system of claim 1 further comprising:
tracking means for storing location information relating to an organizational asset where the submitted pre-mapped electronic document identifies said organizational asset.

16. A workflow integration method for automatically routing pre-mapped electronic documents within an organization's workflow environment, comprising:
defining a routing path for an electronic document through said organization;
storing a plurality of pre-mapped electronic documents, each of which includes at least one data field for receipt of data provided by a user;
retrieving, in response to a request input by a user, one of said plurality of pre-mapped electronic documents from said digital form memory means for use by said user to submit data that is input into at least one of said data fields of said retrieved pre-mapped electronic document; and
automatically storing said data input by said user.

17. The workflow integration method of claim 16 wherein said automatically storing comprises:
extracting at least one of said data input by said user, tracking and authentication information from associated fields in said submitted pre-mapped electronic document; and
populating a record in a relational database with said extracted at least one of data input by said user, tracking and authentication information.

18. The workflow integration system of claim 17 further comprising:
data retrieval means for enabling a user to access said record stored in said relational database to retrieve data therefrom.

19. The workflow integration method of claim 16 further comprising:
transmitting, in response to said user submitting said retrieved pre-mapped electronic document, said submitted pre-mapped electronic document to a destination defined by said routing path for said submitted pre-mapped electronic document.

20. The workflow integration method of claim 16 further comprising:
automatically populating said retrieved pre-mapped electronic document with data stored within a database.

21. The workflow integration method of claim 20 further comprising:
extracting data relevant to said retrieved pre-mapped electronic document from its records.

22. The workflow integration method of claim 16 further comprising:
simultaneously processing said retrieved pre-mapped electronic document by multiple users.

23. The workflow integration system of claim 22 wherein said parallel processing means comprises:
means for parsing said retrieved pre-mapped electronic document into a plurality of sets of said data fields; and
means for enabling a selected subset of said multiple users to input data into only a one of said plurality of sets of data fields.

24. The workflow integration system of claim 23 wherein said parallel processing means further comprises:
tracking means for monitoring the completion status of each of said plurality of sets of data fields.

25. The workflow integration method of claim 16 further comprising:
enabling disparate applications and systems to recognize the data.

26. The workflow integration method of claim 25 wherein said step of enabling comprises:
storing a plurality of templates defined in XML that serve as an interface for integrating with third party systems and applications.

27. The workflow integration method of claim 26 wherein said step of enabling comprises:
creating a predefined data structure tied to an XML schema so that interacting systems understand the data transaction flowing between them.

28. The workflow integration method of claim 16 further comprising:
performing a single source update on the data that characterizes the organizational assets.

29. The workflow integration method of claim 16 further comprising:
storing historical information relating to the submitted pre-mapped electronic document, the source of the submitted data, and a notation of each authentication process completed in the submission of said data.

30. The workflow integration system of claim 16 further comprising:
tracking means for storing location information relating to an organizational asset where the submitted pre-mapped electronic document identifies said organizational asset.
